(19) United States
(12) Patent Application Publication
(10) Pub. No.: US 2011/0237381 A1
(43) Pub. Date: Sep. 29, 2011

(54) WOBBLE MECHANISM

(76) Inventor: Gregor Puchhammer, Vienna (AT)

(21) Appl. No.: 13/132,925

(22) PCT Filed: Jan. 14, 2010
(86) PCT No.: PCT/AT2010/000010

§ 371 Date: Jun. 15, 2011

(30) Foreign Application Priority Data
Jan. 22, 2009 (AT) A 99/2009

(51) Int. Cl. F16H 23/00

(52) U.S. Cl. 475/163

(57) ABSTRACT

A wobble mechanism is provided with a wobble member, which is arranged on an input shaft and has at least one row of force transmitting elements interacting with secondary force transmitting elements arranged on the input side and output side. At least one row of force transmitting elements is formed by magnets (7, 8, 37, 38, 48, 49, 50) arranged on the outside of the wobble member. In this way, low-noise operation is enabled.

The invention relates to a wobble drive whose wobble member is mounted on an input shaft and provided with at least one array of force-transmitting elements that interact with arrays of secondary force-transmitting elements mounted on the input side and output side.

Such known drives for high-ratio reductions are based on the idea of a differential drive, in which two gears having a difference of a few gear teeth are displaced relative to one another. In this connection, the first gear is generally rigidly connected with the housing, while the second gear is connected with the output shaft.

The invention has set itself the goal of creating a wobble drive of this type that can work extremely quietly. This is is achieved in that at least one array of force-transmitting elements is formed by magnets that are mounted on the outside of the wobble member.

Wobble drives according to the invention can be a reduction drive, but also a step-up drive or a setting device, locking device, or positioning device.

If, in the case of a wobble drive, the input shaft and the output shaft that are coaxial are hollow shafts, according to the invention, it is possible to pass operating lines or the like through the two hollow shafts.

When using force-transmitting elements according to the invention, it can be practical to bring the force-transmitting elements out of mesh by changing the angle between the wobble member and the shaft axis. In this way, uncoupling or overload protection can be achieved.

In the following, the invention will be described in greater detail with reference to embodiments shown in the drawings, without being restricted to these examples. In this connection, in figures show in section:

FIG. 1, a wobble drive having a combination of a magnet stage and an ring-toothed pair of bevel gears;

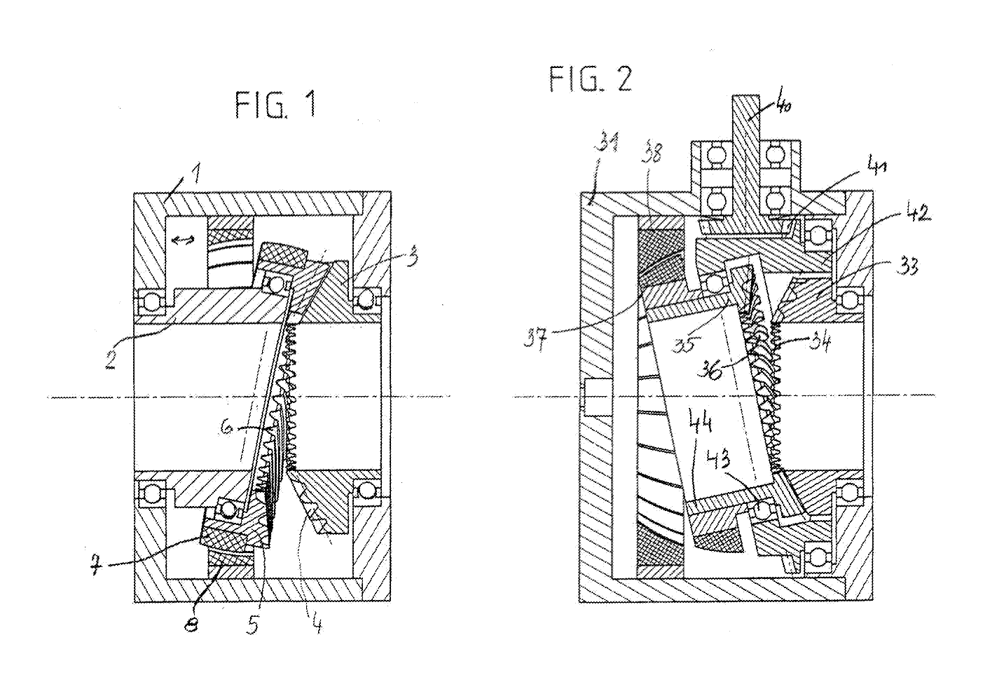

FIG. 2, a wobble drive in which the input and output are offset by 90°;

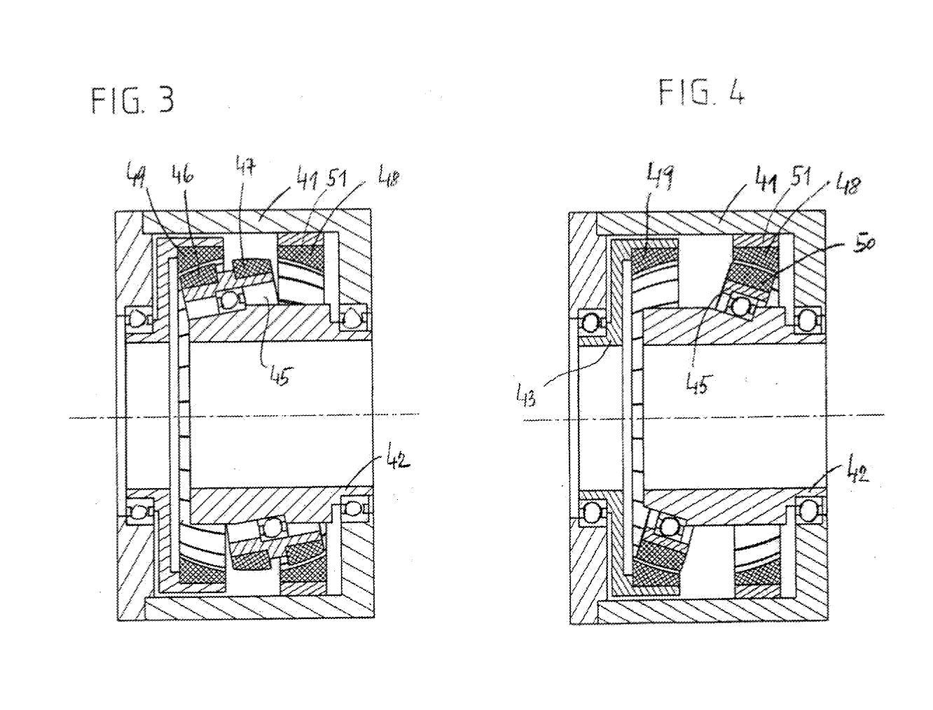

FIG. 3, a wobble drive having a wobble member equipped with two arrays of magnets;

FIG. 4, a wobble drive having a wobble member equipped is with one array of magnets.

According to FIG. 1, an input shaft 2 configured as a tube shaft is mounted in a housing 1. An output shaft 3 coaxial to it is also mounted in the housing 1. This shaft 3 is also a hollow shaft.

The shaft 3 is provided with a ring of bevel-gear teeth 4, which could also be configured as a separate part, connected with the shaft 3.

In known manner, the input shaft 2 carries a wobble element 5 that is provided with ring of gear teeth 6 that mesh with the ring of bevel-gear teeth 4. Force-transmitting elements in the form of magnets 7 are mounted on the outer surface of the wobble element 5 and interact with magnets 8 connected with the housing 1. These magnets 8 form the secondary force-transmitting elements of the wobble drive.

As indicated by a double-headed arrow, the magnets 8 can be axially displaceable.

By making the first stage of the wobble drive a magnet drive stage 7, 8, this can be used to measure the drive moment that acts on the drive. The moment that acts on the wobble element 5 from the output shaft 3 is applied as the output moment to the element. it is applied by magnetic forces to the housing 1. As a result, the wobble element 5 turns, relative to the housing 1, as a function of the output moment that acts on it. This rotation is a measure for the moment and can be measured by means of a known device.

The measurement variable “torque” can be passed to a control device for applications, and can be used for regulation tasks.

The limiting torque can be changed by axial displacement of the ring of magnets 8.

In the embodiment according to FIG. 2, the parts 31, 33, 34, 35, 36, 37, and 38 correspond to the parts 1, 3, 4, 5, 6, 7, and 8 of the arrangement according to FIG. 1.

A significant difference as compared with the embodiment according to FIG. 1 is that the drive takes place at an angle of 90° to the output. The drive shaft 40 is connected with a wobble shaft 42 by bevel gearing 41. The wobble shaft 42 drives the wobble element 44 by an internal bearing 43. The element in turn is equipped with magnets 37 that interact with magnets 38 mounted in the housing 31.

In the embodiments according to FIGS. 3 and 4, an input shaft 42, with which a wobble element 45 is connected, is mounted in a housing 41. In the embodiment according to FIG. 3, the wobble element 45 is equipped with two arrays 46 and 47 of magnets that alternately interact with magnets 48 and 49.

In the embodiment according to FIG. 4, the wobble element 45 is provided with only one array 50 of magnets. The torque of the output shaft 43 is applied to the housing 41 via the magnetic forces and the elastic element 51, and a correspondingly twists the magnetic gear 48. This rotation is a measure of the torque that acts in the transfer path, and can be used for a torque measurement.

Numerous modifications are possible within the scope of the invention. For example, the angle for producing the wobble movement could be changeable. This is advantageous if the play between the interacting carriers is supposed to be changeable.

The wobble element could also be made in two parts that can rotate relative to one another about a common axis of rotation. The two parts should be coupled by a connection element with elastic properties. Since the full torque is transferred by this coupling, the measure of the rotation is a measure for the torque that prevails at the output at any particular time.

1. A wobble drive whose wobble member is mounted on an input shaft and is provided with at least one array of force-transmitting elements that interact with secondary force-transmitting elements mounted on the input side and output side, wherein at least one of the arrays of force-transmitting elements is formed by magnets that are mounted on the an outer surface of the wobble member.

2. The wobble drive according to claim 1, wherein the input shaft or the output shaft are coaxial hollow shafts.

3. The wobble drive according to claim 1, wherein an angle between the wobble element and the shaft axis is changeable.

4. The wobble drive according to claim 1, wherein an array of force-transmitting elements on the input side is axially displaceable.

5. The wobble drive according to claim 1, wherein the input shaft extends at an angle of 90° to the output.

6. The wobble drive according to claim 1, wherein the angle for producing the wobble movement is changeable.

7. The wobble drive according to claim 1, wherein the wobble element has two parts that can rotate relative to one another and have a common axis of rotation.

8. The wobble drive according to claim 1, further comprising
an elastic element that support the torque of the output shaft.
